(19) United States
(12) Patent Application Publication
(10) Pub. No.: US 2023/0031656 A1
(43) Pub. Date: Feb. 2, 2023

(54) METHOD AND DEVICE FOR TRANSFERRING INFORMATION FLOW OF CUSTOMIZED FURNITURE INFORMATION MANAGEMENT AND CONTROL

(71) Applicant: DEHUA TB NEW DECORATION MATERIAL CO., LTD., Huzhou (CN)

(72) Inventors: Xianxu Zhan, Huzhou (CN); Xuqin Xie, Huzhou (XX); Ning Li, Huzhou (CN); Rongrong Li, Huzhou (CN); Zhihui Wu, Huzhou (CN); Wei Xu, Huzhou (CN); Weida Xu, Huzhou (CN); Shixiong Sheng, Huzhou (CN); Ping Wang, Huzhou (CN)

(21) Appl. No.: 17/390,774

(22) Filed: Jul. 30, 2021

(51) Int. Cl. G06Q 10/08; G06K 7/14

(52) U.S. Cl. CPC G06Q 10/087; G06K 7/1413

(57) ABSTRACT

A method and a device for transferring information flow of customized furniture information management and control includes: acquiring customer orders, generating an order code corresponding to the customer order, and transmitting the order code to an order splitting subsystem; generating, by the order splitting subsystem, product drawing information and product configuration information, decomposing the product drawing information and product configuration information to generate part codes and packaging box codes, barcode information of parts and packaging boxes; dividing the product drawing information into process drawing information and non-process drawing information, and transmitting to the ERP subsystem; decoding, by the ERP subsystem, the process drawing information to generate NC code information; and transmitting, by the ERP subsystem, the non-process drawing information to a corresponding department terminal; completing the processing of the part; and sorting and packaging the parts; and then delivering a logistics after the sorting and packaging is completed.

### TECHNICAL FIELD

The present disclosure relates to the technical field of intelligent furniture manufacturing, and in particular, to a method and a device for transferring information flow of customized furniture information management and control.

### BACKGROUND

The mass customization furniture manufacturing process is essentially a process of information collection, transmission, processing and application. How to apply information collection and operational research to mass-customize furniture so that it can gain competitive advantages in cost, speed, and differentiation, will be a new direction in the research of mass-customized furniture. Through information management technology, it can quickly provide customers with customized products with low cost, high quality and short delivery time. Furniture enterprises realize information management and control. In fact, the response of information flow (including: order flow, data flow, logistics, and production flow) is based on management software and advanced equipment (numerical control equipment) to realize management and control of production through information flow.

However, the current information management methods in furniture production have technical problems such as slow response speed and poor production efficiency in the current custom-made furniture manufacturing process. It is difficult to meet the individualization of a huge consumer group and it is urgently needs to be improved.

### SUMMARY

In view of the problems in the prior art, the embodiments of the present disclosure provide a method and a device for transferring information flow of customized furniture information management and control.

One of embodiments of the present disclosure provides a method for transferring information flow of customized furniture information management and control, including the following steps:

S101: acquiring customer orders, generating an order code corresponding to each of the customer orders through an ERP subsystem, and transmitting the order code to an order splitting subsystem;

S102: splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem;

S103: dividing, by the order splitting subsystem, the product drawing information into process drawing information and non-process drawing information, and transmitting the process drawing information and the non-process drawing information to the ERP subsystem;

S104: transmitting, by the ERP subsystem, the process drawing information to a numerical control processing equipment for decoding to generate corresponding machinable NC code information; and transmitting, by the ERP subsystem, the non-process drawing information to a corresponding department terminal;

S105: completing the processing of the part according to the part codes, the barcode information of the parts, and the machinable NC code information; and sorting and packaging the parts according to the barcode information of parts and packaging boxes; and then delivering a logistics after the sorting and packaging is completed.

In one of the embodiments, the method further includes:

Decomposing the product drawing information into part cutting processing information, part hole position processing information, assembly drawing information and drawing information;

Decomposing the product configuration into a product standard configuration BOM and a customized BOM.

In one of the embodiments, the machinable NC code information comprises:

Cutting processing code information formed by decoding the part cutting processing information through cutting and optimizing software, and hole position processing information formed by decoding the part hole position processing information through hole position processing software.

In one of the embodiments, the method further includes:

Processing, by an electronic cutting saw, according to the cutting processing code information, and printing a barcode information label of the part during the processing, the barcode information label being a basis for an identification and flow of the parts during the processing;

Identifying the part through the barcode information label when detecting that the part enters or leaves any process, and collecting processing start information and processing end information of the process into the ERP subsystem;

Processing hole positions of the part according to the hole position processing code information when detecting that the part are transferred to the CNC equipment.

In one of the embodiments, the method further includes:

Sending the assembly drawing information to a terminal of the product packaging logistics department connected to the ERP subsystem;

Acquiring an information type of the drawing information, acquiring a corresponding relevant production department according to the information type, and sending the drawing information to the terminal of the relevant production department;

Sending the product standard configuration BOM and customized BOM to a financial department, a warehouse management department, and a planning department, for the financial department perform cost calculations according to the product standard configuration BOM, for the warehouse management department to perform product configuration and purchase according to the product standard configuration BOM, and for the planning department to perform planning and scheduling according to the customized BOM.

In one of the embodiments, the method further includes:

Sorting, by a sorting department, the parts according to the order information corresponding to the customer order;

Scanning and packaging, by a packaging department, the parts according to the barcode information of the parts and the packaging boxes;

Delivering, by a logistics department, the logistics according to the barcode information of the packaging boxes.

One of the embodiments of the present disclosure provides a device for transferring information flow of customized furniture information management and control, wherein comprising:

An acquisition module configured for acquiring customer orders, generating an order code corresponding to the customer order through an ERP subsystem, and transmitting the order code to an order splitting subsystem;

A decomposition module configured for splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem;

A transmission module configured for dividing, by the order splitting subsystem, the product drawing information into process drawing information and non-process drawing information, and transmitting the process drawing information and the non-process drawing information to the ERP subsystem;

A decoding module configured for transmitting, by the ERP subsystem, the process drawing information to a numerical control processing equipment for decoding to generate corresponding machinable NC code information; and transmitting, by the ERP subsystem, the non-process drawing information to a corresponding department terminal;

A processing module configured for completing the processing of the part according to the part codes, the barcode information of the parts, and the machinable NC code information; and sorting and packaging the parts according to the barcode information of parts and packaging boxes; and then delivering a logistics after the sorting and packaging is completed.

In one of the embodiments, the device further includes:

A second decomposition module configured for decomposing the product drawing information into part cutting processing information, part hole position processing information, assembly drawing information and drawing information;

A third decomposition module configured for decomposing the product configuration into a product standard configuration BOM and a customized BOM.

One of the embodiments of the present disclosure provides an electronic device comprising a memory, a processor, and a computer program stored on the memory and capable of running on the processor, wherein the steps of the method for transferring information flow of customized furniture information management and control according to claim 1 are performed when the computer program is implemented by the processor.

One of the embodiments of the present disclosure provides a non-transitory computer-readable storage medium with a computer program stored thereon, wherein the steps of the method for transferring information flow of customized furniture information management and control according to claim 1 are performed when the computer program is implemented by the processor.

The method and the device for transferring information flow of customized furniture information management and control provided according to at least one embodiment of the present disclosure have the following steps: acquiring customer orders, generating an order code corresponding to the customer order through the ERP subsystem, and transmitting the order code to an order splitting subsystem; splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem; dividing, by the order splitting subsystem, the product drawing information into process drawing information and non-process drawing information, and transmitting the process drawing information and the non-process drawing information to the ERP subsystem; transmitting, by the ERP subsystem, the process drawing information to a numerical control processing equipment for decoding to generate corresponding machinable NC code information; and transmitting, by the ERP subsystem, the non-process drawing information to a corresponding department terminal; completing the processing of the part according to the part codes, the barcode information of the parts, and the machinable NC code information; and sorting and packaging the parts according to the barcode information of parts and packaging boxes; and then delivering a logistics after the sorting and packaging is completed. This can improve the efficiency of the flow of customized furniture information in the manufacturer’s product processing process, and while increasing the processing speed of customized furniture, it can also meet the individual needs of consumer groups.

### BRIEF DESCRIPTION OF DRAWINGS

In order to explain the embodiments of the present disclosure or the technical solutions in the prior art more clearly, the following will briefly introduce the drawings that need to be used in the description of the embodiments or the prior art. Obviously, the drawings in the following description are some of the embodiments of the present disclosure, those of ordinary skill in the art can obtain other drawings based on these drawings without any inventive work.

FIG. 1 is a flowchart illustrating a method for transferring information flow of customized furniture information management and control in an embodiment according to the present disclosure;

FIG. 2 is a structural diagram illustrating a device for transferring information flow of customized furniture information management and control in an embodiment according to the present disclosure;

FIG. 3 is a schematic diagram illustrating a structure of an electronic device in an embodiment according to the present disclosure.

### DESCRIPTION OF EMBODIMENTS

In order to make the objectives, technical solutions, and advantages of the embodiments of the present disclosure clearer, the technical solutions in the embodiments of the present disclosure will be described clearly and completely in combination with the accompanying drawings in the embodiments of the present disclosure. Obviously, the described embodiments are a part of the embodiments of the present disclosure, but not all of the embodiments. Based on the embodiments of the present disclosure, all other embodiments obtained by those of ordinary skill in the art without inventive work shall fall within the protection scope of the present disclosure.

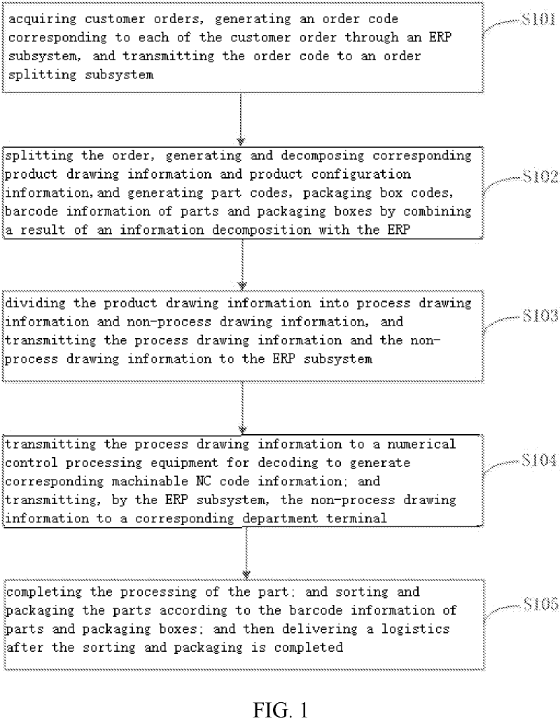

FIG. 1 is a schematic flowchart illustrating a method for transferring information flow of customized furniture information management and control provided by an embodiment according to the present disclosure. As shown in FIG. 1, an embodiment of the present disclosure provides a method for transferring information flow of customized furniture information management and control, including the following steps:

Step S101: acquiring customer orders, generating an order code corresponding to each of the customer orders through an ERP subsystem, and transmitting the order code to an order splitting subsystem;

Specifically, the furniture product model library information established by commonly used design software such as CAD\3DMAX will form a customer order after confirmation by the terminal store customer. After the customer order is obtained, the order code will be formed through the ERP subsystem of the enterprise management software. According to the order code, the store management system transmits the customized household product information in the order to the order splitting subsystem in the enterprise technology department through the enterprise LAN.

Step S102: splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem;

Specifically, the order splitting subsystem may use the order splitting software to split the structure of the customized household product according to the order information to form product drawing information and product configuration information, and then decompose the product drawing information and product configuration information. Among them, the product drawing information can be decomposed into part cutting processing information (configured for determining the size of the parts), part hole position processing information (configured for determining the hole position of the parts), assembly drawing information (configured for product installation guidance) and drawing information (configured for guiding product processing); the product configuration information may be decomposed into product standard configuration BOM (configured for costing, configuration and purchase) and customized BOM (configured for planning production). And the order splitting subsystem may automatically generate part codes and packaging box codes by combining with the enterprise management software ERP subsystem, and form the barcode information (barcode or QR code information) of the parts and packaging boxes.

Step S103: dividing, by the order splitting subsystem, the product drawing information into process drawing information and non-process drawing information, and transmitting the process drawing information and the non-process drawing information to the ERP subsystem;

Specifically, according to the product drawing information, the order splitting subsystem may divide it into process drawing information that requires parts processing and non-process drawing information that does not requires parts processing, and the process drawing information and non-process drawing information may be sent to the ERP subsystem for follow-up processing.

Step S104: transmitting, by the ERP subsystem, the process drawing information to a numerical control processing equipment for decoding to generate corresponding machinable NC code information; and transmitting, by the ERP subsystem, the non-process drawing information to a corresponding department terminal;

Specifically, the process drawing information formed by the splitting involves the part of the numerical control processing, the part may be transmitted to the numerical control processing equipment through the enterprise local area network (Internet) by the enterprise ERP system for decoding, and the machinable NC code information may be produced. The process to produce the machinable NC code information is: decoding, by cutting optimization software (CutRite), the cutting processing information of the parts, to form the cutting processing code information that can be identified by the electronic cutting saw; decoding, by hole position processing software (Imos), the hole position processing information of the parts, to form the hole position processing code information that can be identified by the machining center (CNC). The non-process drawing information that does not involve processing may be directly assigned to the relevant departments by the enterprise ERP subsystem. Among them, the assembly drawing information may be automatically assigned to the product packaging and logistics department, and the drawing information can be downloaded and printed in the relevant production department as needed.

Step S105: completing the processing of the part according to the part codes, the barcode information of the parts, and the machinable NC code information; and sorting and packaging the parts according to the barcode information of parts and packaging boxes; and then delivering a logistics after the sorting and packaging is completed.

Specifically, according to the part code, the barcode information of the parts, and the machinable NC code information, the processing flow of the parts in the workshop can be completed. The specific processing process can be processed by the parts according to the information of the parts cutting and processing. Among them, The electronic cutting saw may perform cutting according to the cutting processing information of the parts optimized by CutRite, and prints out the QR code (barcode information) labels of the parts generated by the ERP through the printer added by the electronic cutting equipment, and the relevant staff will affix it to the corresponding parts. The processing process of the parts in the workshop may be mainly based on the QR code label of each part for identification and circulation, and enters the next process to be processed. Each time the parts are processed in a different process, the code will be scanned before and after processing, and the process information about the start and end of the process will be automatically collected into the ERP system; the machining center (CNC) will process the hole position based on Imos decode information when waiting for the parts to be processed are transferred to the CNC equipment according to the process.

Among them, the QR code label during processing can include the following:

Part information: including the name of the part, the size of the finished product, the cutting size, the material of the plate, etc., mainly used for manual error correction, to prevent the manual judgment from distinguishing the ownership of the parts when the identification of the QR code standard is damaged;

Product information: including order number, production batch number, used to distinguish the time and batch of production plan start during the production process;

Part QR code ID card: including QR code (large) of the plate, reverse side punch code (small) of the plate. The QR code of the plate is unique in the system database, and it is consistent with the file path of the NC code of the front of the plate, such that processing can be made by scanning the QR code in the workshop; the reverse side punch code of the plate is only used for the machining center to retrieve the NC code for the reverse side processing, and the reverse side punch code does not have other functions.

Process route information: ERP analyzes the process route of the part according to the preset conditions, and allocates suitable processing equipment in time to achieve the best process route and the best production capacity of the equipment;

Cutting processing information: including stack number, stack quantity, instructing the cutting operator to sort and stack according to the stack number, and check whether each stack quantity is complete according to the stack quantity, so as to facilitate timely arrangement and transfer to the next section;

Edge banding processing information: the visual effect is important here. Three numbers 0, 1, and 2 are adopted to represent no edge banding, thin edge banding, and thick edge banding. The edge banding operator can process directly by looking at this position;

Drilling processing information: it is divided into drilling mark, whether to draw groove, whether to mill special shape, the visual effect is important here;

Sorting complete set information: according to the visual effect, the sorting operator scans the QR code of the part to record the plate in place, and directly places the complete set of sorting code in the corresponding position, such that the complete set function of all the ordered products can be automatically achieved;

Plate processing status: providing mark for the repaired workpiece, and the operator is clear at a glance, and pays attention to the priority and signs for expedited processing.

In addition, after the processing of the parts is completed, the parts are sorted and packaged according to the barcode information (barcode or QR code) of the parts and the packaging box, and the logistics is delivered after the sorting and packaging is completed. The specific packaging and delivery process can be that the sorting department scans codes and sorts according to different order information, and scanning code and completing inspections can be conducted during processing. After passing the inspection, combined with the barcode information of the outsourcing part in the product configuration information, the packaging department will scan the code and package according to the barcode or QR code information of the box and the barcode information of the parts.

The embodiment of the present disclosure provides a method for transferring information flow of customized furniture information management and control including, acquiring customer orders, generating an order code corresponding to the customer order through the ERP subsystem, and transmitting the order code to an order splitting subsystem; splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem; dividing, by the order splitting subsystem, the product drawing information into process drawing information and non-process drawing information, and transmitting the process drawing information and the non-process drawing information to the ERP subsystem; transmitting, by the ERP subsystem, the process drawing information to a numerical control processing equipment for decoding to generate corresponding machinable NC code information; and transmitting, by the ERP subsystem, the non-process drawing information to a corresponding department terminal; completing the processing of the part according to the part codes, the barcode information of the parts, and the machinable NC code information; and sorting and packaging the parts according to the barcode information of parts and packaging boxes; and then delivering a logistics after the sorting and packaging is completed. This can improve the efficiency of the flow of customized furniture information in the manufacturer’s product processing process, and while increasing the processing speed of customized furniture, it can also meet the individual needs of consumer groups.

On the basis of the above embodiment, the method for transferring information flow of customized furniture information management and control may further include:
sending the assembly drawing information to a terminal of the product packaging logistics department connected to the ERP subsystem;
acquiring an information type of the drawing information, acquiring a corresponding relevant production department according to the information type, and sending the drawing information to the terminal of the relevant production department;
sending the product standard configuration BOM and customized BOM to a financial department, a warehouse management department, and a planning department, for the financial department perform cost calculations according to the product standard configuration BOM, for the warehouse management department to perform product configuration and purchase according to the product standard configuration BOM, and for the planning department to perform planning and scheduling according to the customized BOM.

In the embodiment of the present disclosure, after the product drawing information and the product configuration information are decomposed, the parts cutting processing information, the part hole position processing information, the assembly drawing information and the drawing information, as well as the product standard configuration BOM and customized BOM may be obtained. The assembly drawing information may be allocated to the product packaging logistics department; the drawing information may be allocated to the relevant production department according to the information type, so that the relevant production department can download and print as needed; the product configuration information formed by the splitting order may be purchased and planned according to the production plan, combined with the ERP system, the product configuration information may be allocated to the corporate finance, planning and warehouse management departments, and the bill of materials (BOM) may be produced in the form of a table. Among them, the financial department may perform cost calculation to the product standard configuration BOM, the warehouse management department may perform product configuration and purchase according to the product standard configuration BOM, and the planning department may perform planning and scheduling according to the customized BOM.

The embodiment of the present disclosure arranges information other than the information of part cutting and processing, and the hole position processing information of the parts, so that the parts may be completed in an orderly manner based on product information except other steps (cost calculation, product configuration, procurement, production scheduling, assembly).

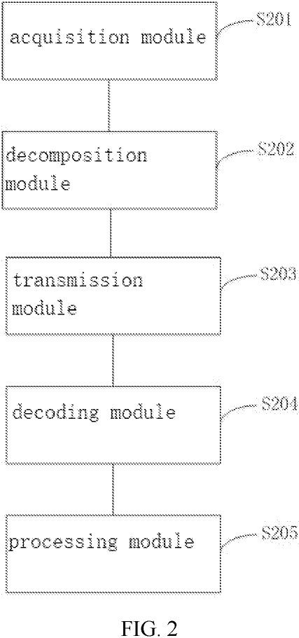

FIG. 2 is a structural diagram illustrating a device for transferring information flow of customized furniture information management and control in an embodiment according to the present disclosure, including: an acquisition module S201, a decomposition module S202, a transmission module S203, a decoding module S204, and a processing module S205, in which:

The obtaining module S201 may be acquiring customer orders, generating an order code corresponding to the customer order through an ERP subsystem, and transmitting the order code to an order splitting subsystem.

The decomposition module S202 may be configured for splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem.

The transmission module S203 may be configured for dividing, by the order splitting subsystem, the product drawing information into process drawing information and non-process drawing information, and transmitting the process drawing information and the non-process drawing information to the ERP subsystem.

The decoding module S204 may be configured for transmitting, by the ERP subsystem, the process drawing information to a numerical control processing equipment for decoding to generate corresponding machinable NC code information; and transmitting, by the ERP subsystem, the non-process drawing information to a corresponding department terminal.

The processing module S205 may be configured for completing the processing of the part according to the part codes, the barcode information of the parts, and the machinable NC code information; and sorting and packaging the parts according to the barcode information of parts and packaging boxes; and then delivering a logistics after the sorting and packaging is completed.

In an embodiment, the device may further include:
a second decomposition module configured for decomposing the product drawing information into part cutting processing information, part hole position processing information, assembly drawing information and drawing information;
a third decomposition module configured for decomposing the product configuration into a product standard configuration BOM and a customized BOM.

In an embodiment, the device may further include:
a second processing module configured for processing by the electronic cutting saw according to the cutting processing code information, and printing the barcode information labels of the parts during the processing process, and the barcode information label is the basis of the part in the processing process for identification and circulation;
an identification module configured to identify the parts through the barcode information label when it is detected that the parts enter or leave any process, and to collect the process start and process end information into the ERP subsystem;
a detection module configured to perform hole position processing on the part according to the hole position processing code information when detecting that the part is transferred to the CNC equipment.

In an embodiment, the device may further include:
a sending module configured to send the assembly drawing information to the terminal of the product packaging logistics department connected to the ERP subsystem;
a second acquisition module configured to acquire the information type of the drawing information, to acquire the corresponding relevant production department according to the information type, and to send the drawing information to the terminal of the relevant production department.
a second sending module configured to send the product standard configuration BOM and customized BOM to the financial department, warehouse management department, and planning department, such that the financial department can perform cost calculations according to the product standard configuration BOM, the warehouse management department can configure and purchase products according to the product standard configuration BOM, and the planning department can perform planning and scheduling according to the customized BOM.

For the specific limitation of the device for transmitting the information flow of customized furniture information management and control, please refer to the above definition of the method for transmitting the information flow of customized furniture information management and control, which will not be repeated here. Each module in the above-mentioned device for transmitting the information flow of customized furniture information management and control can be realized in whole or in part by software, hardware and a combination thereof. The above-mentioned modules may be embedded in the form of hardware or independent of the processor in the computer equipment, or may be stored in the memory of the computer equipment in the form of software, so that the processor can call and execute the operations corresponding to the above-mentioned modules.

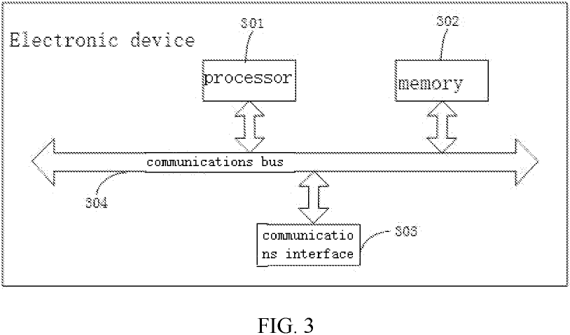

FIG. 3 illustrates a schematic diagram of the physical structure of an electronic device. As shown in FIG. 3, the electronic device may include: a processor 301, a memory 302, a communications interface 303, and a communications bus 304, Among them, the processor 301, the memory 302, and the communications interface 303 communicate with each other through the communications bus 304. The processor 301 can call the logic instructions in the memory 302 to execute the following methods: acquiring customer orders, generating an order code corresponding to each of the customer orders through an ERP subsystem, and transmitting the order code to an order splitting subsystem; splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem; dividing, by the order splitting subsystem, the product drawing information into process drawing information and non-process drawing information, and transmitting the process drawing information and the non-process drawing information to the ERP subsystem; transmitting, by the ERP subsystem, the process drawing information to a numerical control processing equipment for decoding to generate corresponding machinable NC code information; and transmitting, by the ERP subsystem, the non-process drawing information to a corresponding department terminal; completing the processing of the part according to the part codes, the barcode information of the parts, and the machinable NC code information; and sorting and packaging the parts according to the barcode information of parts and packaging boxes; and then delivering a logistics after the sorting and packaging is completed.

In addition, the above-mentioned logical instructions in the memory 302 can be implemented in the form of a software functional unit, and when sold or used as an independent product, they can be stored in a computer readable storage medium. Based on this understanding, the technical solution of the present disclosure essentially, or the part that contributes to the existing technology, or the part of the technical solution, can be embodied in the form of a software product, and the computer software product may be stored in a storage medium, including several instructions used to make a computer device (which may be a personal computer, a server, or a network device, etc.) execute all or part of the steps of the methods described in the various embodiments of the present disclosure. The aforementioned storage medium may include: U disk, mobile hard disk, read-only memory (ROM), random access memory (RAM), magnetic disks or optical disks and other media that can store program codes.

On the other hand, an embodiment of the present disclosure also provides a non-transitory computer-readable storage medium on which a computer program is stored. The computer program may be implemented when executed by a processor to perform the transmission method provided by the foregoing embodiments, for example, including: acquiring customer orders, generating an order code corresponding to each of the customer orders through an ERP subsystem, and transmitting the order code to an order splitting subsystem; splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem; dividing, by the order splitting subsystem, the product drawing information into process drawing information and non-process drawing information, and transmitting the process drawing information and the non-process drawing information to the ERP subsystem; transmitting, by the ERP subsystem, the process drawing information to a numerical control processing equipment for decoding to generate corresponding machinable NC code information; and transmitting, by the ERP subsystem, the non-process drawing information to a corresponding department terminal; completing the processing of the part according to the part codes, the barcode information of the parts, and the machinable NC code information; and sorting and packaging the parts according to the barcode information of parts and packaging boxes; and then delivering a logistics after the sorting and packaging is completed.

The device embodiments described above are merely illustrative, where the units described as separate components may or may not be physically separated, and the components displayed as units may or may not be physical units, that is, they may be located in one place, or they can be distributed to multiple network units. Some or all of the modules can be selected according to actual needs to achieve the objectives of the solutions of the embodiments. Those of ordinary skill in the art can understand and implement it without inventive work.

Through the description of the above implementation manners, those skilled in the art can clearly understand that each implementation manner can be implemented by means of software and a necessary general hardware platform, and of course, it can also be implemented by hardware. Based on this understanding, the above technical solution essentially, or the part that contributes to the existing technology can be embodied in the form of a software product. The computer software product can be stored in a computer-readable storage medium, such as a ROM/RAM, a magnetic disc, an optical disc, etc., and can include several instructions to make a computer device (which may be a personal computer, a server, or a network device, etc.) execute the methods described in each embodiment or some parts of the embodiment.

Finally, it should be noted that the above embodiments are only used to illustrate the technical solutions of the present disclosure, instead to limit them. Although the present disclosure has been described in detail with reference to the foregoing embodiments, those of ordinary skill in the art should understand that: the technical solutions recorded in the foregoing embodiments can be modified, or some of the technical features thereof can be equivalently replaced. These modifications or replacements do not cause the essence of the corresponding technical solutions to deviate from the spirit and scope of the technical solutions of the embodiments of the present disclosure.

What is claimed is:

1. A method for transferring information flow of customized furniture information management and control, wherein comprising the following steps:
S101: acquiring customer orders, generating an order code corresponding to each of the customer order through an ERP subsystem, and transmitting the order code to an order splitting subsystem;
S102: splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem;
S103: dividing, by the order splitting subsystem, the product drawing information into process drawing information and non-process drawing information, and transmitting the process drawing information and the non-process drawing information to the ERP subsystem;
S104: transmitting, by the ERP subsystem, the process drawing information to a numerical control processing equipment for decoding to generate corresponding machinable NC code information; and transmitting, by the ERP subsystem, the non-process drawing information to a corresponding department terminal;
S105: completing the processing of the part according to the part codes, the barcode information of the parts, and the machinable NC code information; and sorting and packaging the parts according to the barcode information of parts and packaging boxes; and then delivering a logistics after the sorting and packaging is completed.

2. The method for transferring information flow of customized furniture information management and control according to claim 1, wherein, said decomposing the product drawing information and product configuration information in step S102 comprises:
decomposing the product drawing information into part cutting processing information, part hole position processing information, assembly drawing information and drawing information;
decomposing the product configuration into a product standard configuration BOM and a customized BOM.

3. The method for transferring information flow of customized furniture information management and control according to claim 2, wherein the machinable NC code information comprises:
cutting processing code information formed by decoding the part cutting processing information through cutting and optimizing software, and hole position processing information formed by decoding the part hole position processing information through hole position processing software.

4. The method of transferring information flow of customized furniture information management and control according to claim 3, wherein said completing the processing of the part according to the part codes, the barcode information of the parts, and the machinable NC code information in step S105 comprises:
processing, by an electronic cutting saw, according to the cutting processing code information, and printing a barcode information label of the part during the processing, the barcode information label being a basis for an identification and flow of the parts during the processing;
identifying the part through the barcode information label when detecting that the part enters or leaves any process, and collecting processing start information and processing end information of the process into the ERP subsystem;
processing hole positions of the part according to the hole position processing code information when detecting that the part are transferred to the CNC equipment.

5. The method for transferring information flow of customized furniture information management and control according to claim 2, wherein the method further comprises:
sending the assembly drawing information to a terminal of the product packaging logistics department connected to the ERP subsystem;
acquiring an information type of the drawing information, acquiring a corresponding relevant production department according to the information type, and sending the drawing information to the terminal of the relevant production department;
sending the product standard configuration BOM and customized BOM to a financial department, a warehouse management department, and a planning department, for the financial department perform cost calculations according to the product standard configuration BOM, for the warehouse management department to perform product configuration and purchase according to the product standard configuration BOM, and for the planning department to perform planning and scheduling according to the customized BOM.

6. The method for transferring information flow of customized furniture information management and control according to claim 2, wherein, said sorting and packaging the parts according to the barcode information of parts and packaging boxes; and then delivering a logistics after the sorting and packaging is completed in step S105:
sorting, by a sorting department, the parts according to the order information corresponding to the customer order;
scanning and packaging, by a packaging department, the parts according to the barcode information of the parts and the packaging boxes;
delivering, by a logistics department, the logistics according to the barcode information of the packaging boxes.

7. A device for transferring information flow of customized furniture information management and control, wherein comprising:
an acquisition module configured for acquiring customer orders, generating an order code corresponding to the customer order through an ERP subsystem, and transmitting the order code to an order splitting subsystem;
a decomposition module configured for splitting, by the order splitting subsystem, the order according to the order code, generating corresponding product drawing information and product configuration information, decomposing the product drawing information and product configuration information, and generating part codes, packaging box codes, barcode information of parts and packaging boxes by combining a result of an information decomposition with the ERP subsystem;
a transmission module configured for dividing, by the order splitting subsystem, the product drawing information into process drawing information and non-process drawing information, and transmitting the process drawing information and the non-process drawing information to the ERP subsystem;
a decoding module configured for transmitting, by the ERP subsystem, the process drawing information to a numerical control processing equipment for decoding to generate corresponding machinable NC code information; and transmitting, by the ERP subsystem, the non-process drawing information to a corresponding department terminal;
a processing module configured for completing the processing of the part according to the part codes, the barcode information of the parts, and the machinable NC code information; and sorting and packaging the parts according to the barcode information of parts and packaging boxes; and then delivering a logistics after the sorting and packaging is completed.

8. The device for transferring information flow of customized furniture information management and control according to claim 7, wherein the device further comprises:
a second decomposition module configured for decomposing the product drawing information into part cutting processing information, part hole position processing information, assembly drawing information and drawing information;
a third decomposition module configured for decomposing the product configuration into a product standard configuration BOM and a customized BOM.

9. An electronic device comprising a memory, a processor, and a computer program stored on the memory and capable of running on the processor, wherein the steps of the method for transferring information flow of customized furniture information management and control according to claim 1 are performed when the computer program is implemented by the processor.
